(19) United States
(12) Patent Application Publication
(10) Pub. No.: US 2013/0213391 A1
(43) Pub. Date: Aug. 22, 2013

(54) SUGAR AERATION CLARIFIER

(71) Applicant: STUART J. WARD, Camas, WA (US)

(72) Inventor: STUART J. WARD, Camas, WA (US)

(21) Appl. No.: 13/848,022

(22) Filed: Mar. 20, 2013

Related U.S. Application Data
(63) Continuation-in-part of application No. 12/683,307, filed on Jan. 6, 2010.
Application No. 12/683,307 is a continuation-in-part of application No. 13/160,459, filed on Jun. 14, 2011, now Pat. No. 8,431,022.
Application No. 13/160,459 is a continuation-in-part of application No. 12/856,053, filed on Aug. 13, 2010, now abandoned.
Application No. 12/856,053 is a continuation-in-part of application No. 12/683,340, filed on Jan. 6, 2010, now abandoned.

(51) Int. Cl. C13K 13/00

(52) U.S. Cl. CPC C13K 13/007
USPC 127/12

(57) ABSTRACT

A sugar aeration clarifier includes: multi-stage flocculator having a chemical injection port an aeration mixing chamber; a separation tank having an inlet distributor, separator plate pack, effluent discharge weir, and inclined sludge plate; an adjustable height clear well riser overflowing into a clear well; an aeration injector recirculating clarified sugar syrup from the clear well to the aeration mixing chamber; and a skimmer to remove agglomerated retentate from the separation tank surface over the sludge plate into a sludge collector portion.

### CROSS-REFERENCE TO RELATED APPLICATION

This application is a continuation-in-part of and claims priority to the following co-pending U.S. patent application Ser. No. 12/683,307, filed Jan. 6, 2010 and application Ser. No. 13/160,459, filed Jun. 14, 2011. Application Ser. No. 13/160,459 is a continuation-in-part of application Ser. No. 12/856,053, filed Aug. 13, 2010 and application Ser. No. 12/683,340, filed Jan. 6, 2010. Each of the preceding listed applications is hereby incorporated by reference in its entirety.

### FIELD OF THE INVENTION

The present invention relates to aqueous sugar solution clarification apparatus and methods. More particularly, the present invention relates to apparatus and methods for sequential clarification of aqueous sugar cane juice in continuous-flow applications.

### BACKGROUND

At present, the production of sugar (or white sugar) from sugar cane comprises a certain number of treatments implemented in a sugar mill, followed by a certain number of supplementary treatments implemented in a refinery. Generally, the principal treatment steps in the sugar mill are: the extraction of the sugar by crushing/pressing of the cane or by diffusion which leads to a raw sugared juice; the clarification of this juice by addition of lime; neutralization of the latter by carbon dioxide (in the case of sugar beet) or acids and decantation of the thus treated juice; the concentration of the resulting juice; and, finally, the crystallization and spinning of the sugar generally in three steps, which leads to raw sugar and molasses being obtained. In the refinery, the operations to which the raw sugar is subjected are essentially a fining (washing of the crystals with a saturated aqueous sugar solution then spinning) in order to eliminate the impurities situated on the surface of the crystals, then re-dissolving the resulting sugar for a further clarification, decolorization, crystallization and spinning. Because of the relatively high purity requirement of the syrup which is subjected to this crystallization, the latter operation is more difficult than in the sugar mill and requires two to three crystallization/separation steps. The purity of the run-off from the last crystallization/separation step is still not enough, and the sugar which it contains is extracted by a complementary crystallization of 3 or 4 steps, termed crystallization “of low grade sugars”, which leads to the production of a very colored sugar, which is recycled at the head of the refinery, and of molasses. The high viscosity of the product subjected to this crystallization makes the latter costly in material and in energy.

The following represents a list of known related art. The teachings of each of the citations below (which does not itself incorporate essential material by reference) are herein incorporated by reference. None of the above inventions and patents, taken either singularly or in combination, is seen to describe the instant invention as claimed:

| Reference: | Issued to: | Date of Issue/Publication: |
|---|---|---|
| 1,180,089 | Thompson et al. | April 1916 |
| 2,440,514 | Karlstrom | April 1948 |
| 3,179,252 | Vrablik | April 1965 |
| 3,532,218 | Von Blottnitz | October 1970 |
| 3,545,620 | Thom | December 1970 |
| 3,660,284 | Camp | May 1972 |
| 3,710,941 | Brociner | January 1973 |
| 3,764,013 | Eisenmann | October 1973 |
| 3,779,910 | Chatfield | December 1973 |
| 4,055,494 | Emmett, Jr. | October 1977 |
| 5,554,227 | Kwok et al. | September 1996 |

U.S. Pat. No. 1,180,089 to Thompson et al teaches the use of air injection and floatation in a vertical flow system to separate metal ores from gangue, by introducing a stream of air-mixed oil. The patent is specific to removing gangue from mineral ores and teaches nothing relating to the unique characteristics of aqueous sugar juices, angled plate separators, or submerged effluent weir systems.

U.S. Pat. No. 2,440,514 to Karlstrom teaches a vertical flow raw-water purification process utilizing air-floatation aided by vertical flow schemes with injection of trivalent ionic salts to enhance the colloidal effect, with slow vertical rotary-agitation to enhance separation. The patent is specific to purifying water and teaches nothing relating to the unique characteristics of aqueous sugar juices, angled plate separators, or submerged effluent weir systems.

U.S. Pat. No. 3,179,252 to Vrablik teaches a vertical flow aeration/flocculation process to purify water which is similar to the preceding, except using a separate pressurization tank for aerating the water and then providing a slower depressurization step in order to permit flocculent particles to nucleate or adhere to air bubbles. The patent is specific to purifying water and teaches nothing relating to the unique characteristics of aqueous sugar juices, angled plate separators, or submerged effluent weir systems.

U.S. Pat. No. 3,532,218 to Von Blottnitz teaches an improved apparatus and method for vertical flow aeration systems of injecting dilute flocculent into a stream of “slimy” ore at higher velocity to produce more rapid and effective contact of the flocculent with the ore contaminants for rapid filtering the first stage. The patent is specific to removing impurities from certain types of mineral ores and teaches nothing relating to the unique characteristics of aqueous sugar juices, angled plate separators, or submerged effluent weir systems.

U.S. Pat. No. 3,545,620 to Thom teaches recirculation of non-aerated flocculent-treated wastewater in vertical-flow reaction chambers, using standard rotating auger-style agitator, in order to initiate additional flocculation prior to discharge into rectangular sedimentation/surface scraping tanks. The patent is specific to purifying water and teaches nothing relating to the unique characteristics of aqueous sugar juices, angled plate separators, or submerged effluent weir systems.

U.S. Pat. No. 3,660,284 to Camp teaches using an initial higher-concentration flocculent in a higher velocity (non-aerated) waste stream to provide smaller-sized flocculated particles for rapid pre-filtering, in order to reduce overall system treatment time. Camp specifies using a rotating rotor-stator combination to increase mean velocity gradients of the flocculated water, and expose the flocculated water to variable velocity gradients. The patent is specific to purifying water and teaches nothing relating to the unique characteristics of aqueous sugar juices, angled plate separators, or submerge effluent weir systems.

U.S. Pat. No. 3,710,941 to Brociner teaches a method of filtering grit from sewage flows by agitating the inlet stream with air along the inlet wall, in order to increase particle and stream velocity in the recirculation path, and then redirecting the flow downward at the opposite wall using a surface baffle, thereby directing particulates toward a bottom sludge trench through the circular flow. The patent is specific to removing gross amounts of grit material from water using redirection baffles with air used merely to accelerate flows toward the redirect baffles.

U.S. Pat. No. 3,764,013 to Eisemann teaches methods for separating gross amounts of paint from water by mixing the paint-water waste with coagulant, introducing air into the mixture to cause it to foam, skimming the resulting foam and passing the resulting effluent of reduced/diluted paint-water mixture through a mechanical filter.

U.S. Pat. No. 3,779,910 to Chatfield teaches passing flocculated wastewater past sloped sedimentation trays and recirculating sludge supernate into the flocculated stream to increase flocculent nucleation.

U.S. Pat. No. 4,055,494 to Emmett teaches a large settling tank with a submerged central sump, peripheral surface overflow weir without height adjustment, and a centerline vertical flocculator column containing rotating mixers, she central drive system connected to large rotating “rake” arms which scrape the bottom of the tank to push sediment into the submerged sump. Emmett is, in essence, simply a large settling tank with a complex bottom scraper. The flocculator column also incorporates rotating mechanisms which are (like the rake) submerged in sugar syrup and so subject to substantial wear and buildup of crystal and/or high viscosity sediments, with very high maintenance needs and consequently high downtime.

U.S. Pat. No. 5,554,227 to Kwok et al., teaches a process including several filtration steps, flocculation and settling/skimming. Kwok is primarily directed to the chemical processes, rather than an efficient apparatus for carrying out such processes. Kwok teaches separating these process steps into separate tank/pump apparatus, effectively rendering it a batch process rather than the more efficient and compact all-in-one flow-through apparatus and process of Applicant. Kwock's process leads to the production of a raw sugar with low coloration termed SVLC “Super Very Low Color” by linking the operations of filtration over a membrane, of softening and of crystallization. Additionally, Kwok discloses only a conventional flocculation tank agitated by a screw/propeller device and recirculation pump, from which the flocculent/syrup slurry mixture is then transferred to a decanting tank for gravity settling, rather than an inline apparatus, and which is not combined with aeration mixing chamber for improved efficiency. This method permits a simplification of the refining of the raw sugar and in particular the elimination of the operations of fining and purification. It permits likewise the implementation of a chromatography step in order to recover the sugar from the molasses and thus to improve the extraction yield of the sugar till. This chromatography generally leads to the production of two fractions, i.e. an extract rich in sugar and a raffinate containing the impurities from the sugar. Process using chromatography as a means of purification of the juices from sugar beet after their clarification, softening and concentration and before crystallization are known.

Starting from syrup with purity (percentage by weight of sugar with respect to the dry material) of approximately 90%, chromatography permits this purity to be raised to at least 94%, which is still low purity for supporting follow-on processing. The crystallization of such syrup in three crystallization/separation steps can produce white sugar and molasses with purity of approximately 60%. Economical production of white sugar from sugar cane or sugar beet juice requires starting the crystallization process from syrup with purity much higher than sugar beet syrup, i.e. of the order of 98% instead of 94%. With purity levels of only 94%, it becomes impractical to produce white sugar with a good yield by means of crystallization with only three crystallization/separation steps because, in order to preserve the quality of the produced sugar, it is not possible to crystallize more than 50 to 60% of the sugar present in each crystallization/separation step. These methods are prohibitively expensive and complex for mass production of high-grade white sugar, so the application of these methods to sugar cane juice industrial processes is increasingly impractical from an economic point of view.

U.S. Pat. No. 6,440,222 to Donovan et al, refers to air injection in order to agglomerate color-forming contaminants prior to a multi-stage mechanical filtration/electro dialysis process, but does not describe an apparatus to perform the air injection/agglomeration process. Donovan's process merely presumes a supply of high concentration sugar juice, which then is passed through multiple filter steps to produce high-concentration juice for more efficient crystallization. Applicant's invention provides an economically efficient apparatus and method to produce such a high concentration sugar juice which can be either be fed into conventional crystallization processes, providing higher yields without resort to the processes described in Donovan, or fed into pre-crystallization processes requiring higher concentration and higher purity inputs, such as described in Donovan.

One solution to this problem would be to prolong the crystallization by two or three crystallization/separation steps termed “depletion steps”—in effect reproducing crystallization of low grade products implemented in the refinery. Applicant's apparatus and process avoid the need for such extra—and costly—steps.

One objective of Applicant's invention is therefore to resolve such problems and disadvantages in an economical manner. Applicant discloses apparatus and process to improve the efficiency of refining sugar (or “white sugar”) from a sugared juice, such as raw juice from sugar cane or from sugar beets, containing sugars and impurities, by providing a higher purity sugar syrup for subsequent crystallization steps. The starting material used in Applicant's apparatus and process is the sugar syrup concentrated from raw sugar carte juice, sugar beet juice, or raw sugar juice from other plant sources or other processes.

Thus, although the known art addresses many methods of using settling tanks and flocculent to clarify water, and discloses chemical processes for clarifying sugar syrup, the art does not provide a simple and efficient apparatus to accomplish clarification of sugar syrup with low maintenance requirements and small physical footprint.

### SUMMARY AND ADVANTAGES

Applicant's apparatus for clarifying sugar syrup includes, generally, a separation tank; a transverse-mounted sludge plate extending from below the liquid operating level to at least the upper edge of the separation tank end wall at an angle; a flocculator portion discharging into the separation tank and having an aeration mixing chamber, an aeration injection port, and one or more chemical injection ports disposed between the flocculator inlet and the aeration injection port; one or more effluent weirs within the separation tank and having an enclosed top portion, a bottom inlet, and discharging to a clear well riser; a clear well including a discharge and one or more clear well risers corresponding to the effluent weirs extending to a riser discharge which defines the liquid operating level of the apparatus; an aeration injector fed by the clear well and discharging to the flocculator aeration injection port; a surface skimmer; and, a sludge collection portion to receive retentate from the surface skimmer.

The apparatus may include wherein the sludge plate angle is in the range 30° to 50° from horizontal.

The apparatus may include a separator plate pack mounted within the separation tank having a plurality of inclined, spaced apart, parallel plates, wherein each effluent weirs is mounted below the separator plate pack.

The apparatus may include wherein the separator plate pack angle is in the range 55° to 65° from horizontal.

The apparatus may include an inlet distribution box mounted within the separation tank having an inlet in fluid communication with the flocculator portion discharge and an outlet disposed within the separation tank interior volume below the liquid operating level to evenly distribute flow across the separation tank.

The apparatus may include a plurality of flocculator stages disposed in series, with the final flocculator stage disposed to feed into the aeration mixing chamber, and each flocculator stage having a chemical injection port proximate its respective upstream portion.

The apparatus may include wherein the aeration injection port is disposed proximate the upstream end of the aeration mixing chamber.

The apparatus may include wherein each flocculator stage comprises an elongated section of pipe mounted substantially horizontally and oriented in an opposed flow direction from the preceding stage, and the aeration mixing chamber comprising an elongated horizontal pipe having greater cross sectional area than each of the plurality of flocculator stages, and having one or more outlets in fluid communication with the inlet distribution box, and oriented in an opposed flow direction from the final flocculator stage.

The apparatus may include wherein each effluent weir comprises an elongated pipe extending from a first end proximate the separation tank first side wall to the effluent weir discharge proximate the separation tank second side wall, with the weir pipe cross section comprising a diamond shape oriented with a closed apex on top.

The apparatus may include wherein the effluent weir pipe cross section is substantially square.

The apparatus may include wherein the interior cross section of each of the one or more effluent weirs extends radially beyond the interior cross section of the corresponding clear well riser lower portion.

The apparatus may include wherein the height of each clear well riser discharge is adjustable, thereby adjusting the apparatus liquid operating level.

The apparatus may include wherein the aeration injector comprises a turbine pump including a suction in fluid communication with the clear well, such that the turbine pump recycles sugar syrup from the clear swell during normal operation.

The apparatus may include wherein the surface skimmer includes a cyclical drive mechanism mounted above the separation tank and extending from a first end proximate the separation tank second end wall to a second end proximate the separation tank first end wall; a plurality of paddles coupled to the drive mechanism, each of the plurality of paddles extending transversely across the separation tank; wherein, the cyclical drive mechanism cyclically moves each paddle of the plurality of paddles from approximately the respective first end wall to approximately the respective second end wall into contact with and over the sludge plate, thereby skimming retentate from the surface of the sugar syrup in the separation tank and moving the retentate across the sludge plate surface into the sludge collection portion.

The apparatus may include wherein each paddle includes a rigid coupling flange adapted to couple to the cyclical drive mechanism; and, a flexible wiper coupled to and extending beyond the rigid coupling flange, wherein the flexible wiper engages along the surface of the sludge plate to push retentate off the sludge plate into the sludge collection portion.

The apparatus may include wherein the sludge collection portion includes a sludge collection hopper abutting the separation tank second end wall connectable to a sludge pump having suction in fluid communication with the sludge collection hopper and a discharge connectable to a sludge disposal system.

The apparatus may include wherein each clear well riser includes an open top end; a movable weir discharge member slidingly engageable over the clear well riser top end; a sealing member disposed between the clear well riser top end and the movable weir discharge member to seal there between; and, a locking member selectively engageable against the movable weir discharge member and the clear well riser top end at user-selectable heights.

An apparatus for clarifying sugar syrup includes a liquid tank having sidewalls and a bottom wall, a collector, the collector including an effluent weir portion adapted to mount below the normal operating liquid level of the tank and a discharge portion in fluid communication with the effluent weir portion, with the effluent weir portion further comprising: an elongated pipe extending longitudinally from a first end to a second end, the pipe including an enclosed top portion forming a peaked transverse cross-section extending from an apex downward, and longitudinally opposed first and second sidewalk extending from the respective top portion to respective first and second sidewall bottom edges, the first and second sidewall bottom edges spaced apart from each other to define a longitudinally-oriented open bottom channel providing fluid communication between the pipe interior and the tank interior volume, and further wherein the effluent weir portion second end is adapted to couple to a sidewall of the liquid tank; and, the discharge portion comprising a riser extending from an inlet couplable to the tank sidewall exterior in fluid communication with the effluent weir portion second end, and an outlet disposed higher than the inlet.

The apparatus may include wherein the discharge portion includes a height-adjustable discharge portion outlet.

The apparatus may include wherein the discharge portion includes a movable sleeve member slidingly engageable over the riser outlet; a sealing member disposed between the outlet and the movable sleeve member to seal there between; and, a locking member selectively engageable against the movable weir discharge member and the clear well riser top end at user-selectable heights.

The apparatus may include wherein the transverse cross section of the collection portion pipe second end extends beyond the cross-section of the discharge portion inlet.

Applicant's sugar aeration clarifier apparatus/process receives this concentrated raw sugar syrup (typically heated to between 135° F. and 190° F.), which contains sugars and high concentrations of non-sugar matter, and then concentrates, clarifies and decolorizes the input by a series of steps, including: an intermediate continuous flow reaction of the sugar syrup passing through an enclosed pipe chamber (flocculator) for a holding period of 5 to 120 seconds in order to facilitate chemical coagulation and flocculation of the sugar syrup contaminant particles for agglomeration; aeration of the sugar syrup within the flocculator via an aeration-recirculation portion to further agglomerate the particles, thereby initiating formation of a retentate and a filtrate; passing the aerated sugar syrup from the flocculator into the separation tank, where it is evenly distributed by an inlet distribution box; separation of the retentate from the filtrate by passing the aerated sugar syrup through a plate separator pack composed of multiple plates, preferably angled at 55-65 degrees, which facilitate laminar flow conditions as well as provide a separation surface for agglomerating retentate particles; concentrating the retentate (mud) at the surface of the sugar syrup the separation tank to obtain a floating skimmable mud; further concentration of the retentate (“mud”) by a mechanical skimmer system moving across the syrup surface and up an inclined sludge plate, such that any clarified syrup (“filtrate”) drains back to the separation tank and the thickened mud is removed to a sludge hopper for further mill processing; and, final extraction of the clarified syrup filtrate from separation tank through effluent collection pipe weirs to a clear well for further mill processing of the clarified sugar syrup and sludge. This clarification eliminates a high proportion of non-dissolved contaminants from the raw sugar juice, thereby reducing production of molasses at later processing steps within the mill, which increases the global yield.

The apparatus and process provide additional advantage in providing continuous processing capability over a wide temperature range, rather than hatching. Continuous processing is more efficient, requiring less cleaning and startup time and maintenance. Additionally, as the processes operate at an elevated temperature range of 135°-190° F., continuous processing reduces energy consumption in eliminating heating requirements for large intermediate storage tanks required to accumulate syrup reservoirs between processing stages.

Applicant's apparatus and process provide for continuous flow operation. The total retention time of the apparatus or process, operating in continuous flow, is 10 to 30 minutes.

The retentate floats to the surface of the separation tank, where it is mechanically concentrated and skimmed by pushing it up an inclined sludge plate at an angle of 30 to 50 degrees pitch. The collected mud is then dropped into a sludge hopper for removal to further mill processing.

The clarified syrup passes out of the separation tank through effluent weir piping into a clear well, for recirculation and discharge.

The apparatus and process can include decolorization of the filtrate, before it is subjected to the later crystallization operation, which is captured within the retentate mud.

Another object of the “sugar aeration clarifier” clarification process is to eliminate the major portion of the impurities and/or suspended solid materials in the sugar syrup.

Raw sugar juice (“syrup”) is supplied directly from a mill sugar-juice concentrator (or an intermediate holding tank or other source) to the “sugar aeration clarifier” at the flocculator inlet (typically pre-heated to a range of 135° F.-190° F.). In the flocculator, it is mixed under brisk agitation—with or without chemical dosing—with a continuous flow holding period of 5 to 120 seconds. Dosing chemicals can be supplied in a staged injection process at multiple points along the flocculator. The sugar syrup is then directed into and evenly distributed within the separation tank by the inlet distribution box. The sugar syrup then passes in a “cross-counter” flow manner through a corrugated separator plate pack, preferably angled at 55-65 degrees, which facilitates laminar flow conditions as well as providing separation surfaces to encourage formation of agglomerating retentate particles. “Cross-counter” the syrup flows “across” the separation tank and plate pack and downward towards the filtrate collection pipe weirs while the agglomerated retentate particles float upward in the “counter” direction toward the surface, thus a “cross-counter” flow.

The agglomerated retentate particles mixed with air float to the surface of the separation tank where they are concentrated and skimmed by a mechanical skimmer. The agglomerated particles are thickened as they are moved along the liquid surface and up the inclined sludge plate, with the clarified syrup filtrate draining back to the separation tank. The retentate (mud) is removed at the top for further mill processing to an adjacent sludge hopper.

Clarified syrup filtrate enters and passes through collection pipe weirs to an effluent collection tank (or “clear well”). From the clear well, 10 to 50 percent of the clarified syrup is recirculated back to the flocculator through the aeration system using a regenerative turbine pump. Alternatively an aeration injection point at the side of the separation tank could be used for the aeration-recirculation return. The remaining clarified syrup is removed from the clear well via discharge which may comprise an overflow outlet or, alternatively, a pump system.

Higher density retentate solids sink to the separation tank bottom, to be removed via a bottom drain located. Submerged effluent collection weirs avoid accumulation of crusts along surface overflow weir edges which can reduce flow efficiency, effect level control by altering the effective weir edge height, and entrain solid contaminants.

The resulting clarified and decolorized sugar syrup filtrate from the clear well discharge is then supplied to the mill for further processing, and the retentate “mud” is supplied to the mill for disposal or reprocessing.

With respect to a conventional sugar mill, Applicant's apparatus and process provide an extraction yield for the sugar—calculated at the entry to the crystallization stage—of over 99%.

The apparatus and method of the present invention presents numerous advantages, including: (1) improved removal of impurities; (2) ability to operate in a continuous processing mode; (3) improved mixing of dosed chemicals with the bulk fluid; (4) improved mixing of gas bubbles within the bulk fluid; (5) improved control of system dwell time; (6) increased recovery of clarified syrup effluent from a given volume of raw sugar juice; (7) compact system footprint; (8) system portability; (9) easier system cleaning; (10) reduced maintenance and downtime; (11) reduced operating costs; (12) greater and simpler operator control over the system by adjusting liquid operating levels and recirculation proportions; (13) easier integration with preceding and follow-on processes; (14) improved chemistry control; and, (15) scalability.

Additional advantages of the invention will be set forth in part in the description which follows, and in part will be obvious from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 shows a top view of an embodiment.

FIG. 2 shows an end view of an embodiment.

FIG. 3 shows a partial cutaway side view of an embodiment.

FIG. 4 shows a partial cutaway end view of an embodiment.

FIG. 5 shows a partial cutaway side view of an embodiment.

FIG. 6 shows a partial cutaway top view of an embodiment.

FIG. 7 shows a partial cutaway end view of an embodiment.

FIG. 8 shows an isolation view of a clear well riser of an embodiment.

FIG. 9 shows an isolation view of a clear well and risers.

FIG. 10 shows a partial cutaway isolation view of a clear well and risers.

FIG. 11 shows an isolation perspective view of a clear well and risers.

FIG. 12 shows a partial cutaway isolation perspective view of a clear well and risers.

FIG. 13 shows a partial cutaway of an isolation view of a riser movable discharge.

FIG. 14 shows a transverse cutaway of an isolation view of an effluent weir and riser bottom portion.

FIG. 15 shows an isolation top view of a skimmer.

FIG. 16 shows schematic cutaway side view of a skimmer.

FIG. 17 shows an isolation view of a skimmer cyclical drive mechanism.

FIG. 18 shows a schematic side view of a skimmer and sludge plate.

FIG. 19 shows a partial cutaway isolation side view of a skimmer and sludge plate.

FIG. 20 shows an isolation perspective view of a skimmer paddle.

### REFERENCE NUMBERS USED IN DRAWINGS

Turning now descriptively to the drawings, in which similar reference characters denote similar elements throughout the several views, the figures illustrate the _ of the present invention. With regard to the reference numerals used, the following numbering is used throughout the various drawing figures:
10 First embodiment
12 Separation tank
14 Sludge Plate
16 Flocculator Portion
18a First Effluent Weir
18b Second Effluent Weir
18c Third Effluent Weir
20 Clear Well
22a First Clear Well Riser
22b Second Clear Well Riser
22c Third Clear Well Riser
24 Aeration Injector
26 Surface Skimmer
28 Sludge Collection Portion
30 Separation Tank Bottom Wall
32 Separation Tank First End Wall
34 Separation Tank Second End Wall
36 Separation Tank First End Wall Bottom Portion
38 Separation Tank Second End Wall Bottom Portion
40 Separation Tank First End Wall Top Portion
42 Separation Tank Second End Wall Top Portion
44 Separation Tank First Sidewall
46 Separation Tank Second Sidewall
48 Separation Tank First Sidewall Bottom Portion
50 Separation Tank Second Sidewall Bottom Portion
52 Separation Tank First Sidewall Top Portion
54 Separation Tank Second Sidewall Top Portion
56 Sludge Plate First Lateral Side
58 Sludge Plate Second Lateral Side
60 Separation Tank Interior Volume
62 Liquid Operating Level
64 Sludge Plate First End
66 Sludge Plate Second End
68 Separation Tank Second End Wall Upper Edge
70 Flocculator Portion Inlet
72 Flocculator Portion Outlet
74 Aeration Mixing Chamber
76 Aeration injection Port
78 Aeration Mixing Chamber Upstream End
80 Turbine Pump
82a First Effluent Weir Top Portion
82b Second Effluent Weir Top Portion
82c Third Effluent Weir Top Portion
84a First Effluent Weir Bottom Inlet
84b Second Effluent Weir Bottom Inlet
84c Third Effluent Weir Bottom inlet
86a First Effluent Weir Discharge
86b Second Effluent Weir Discharge
86c Third Effluent Weir Discharge
88a First Clear Well Riser Inlet
88b Second Clear Well Riser Inlet
88c Third Clear Well Riser Inlet
90 Clear Well Bottom Wall
92 Clear Well First Sidewall
94 Clear Well Second Sidewall
96 Clear Well Third Sidewall
98 Clear Well First Sidewall Bottom Portion
100 Clear Well Second Sidewall Bottom Portion
102 Clear Well Third Sidewall Bottom Portion
104 Clear Well First Sidewall Top Portion
106 Clear Well Second Sidewall Top Portion
108 Clear Well Third Sidewall Top Portion
110 Clear Well Discharge
112a First Clear Well Riser Bottom Portion
112b Second Clear Well Riser Bottom Portion
112c Third Clear Well Riser Bottom Portion
114a First Clear Well Riser Discharge
114b Second Clear Well Riser Discharge
114c Third Clear Well Riser Discharge
116 Separator Plate Pack
118 Separator Plate Pack Plate
120 Separator Plate Pack Plate Top Edge
122 Separator Plate Pack Plate Bottom Edge
124 Inlet Distribution Box
126 Inlet Distribution Box Inlet
128 Inlet Distribution Box Outlet
130 First Flocculator Stage
132 Second Flocculator Stage
134 Third Flocculator Stage
136 First Flocculator Stage Upstream Portion
138 Second Flocculator Stage Upstream Portion
140 Third Flocculator Stage Upstream Portion
142 First Flocculator Stage Downstream Portion
144 Second Flocculator Stage Downstream Portion
146 Third Flocculator Stage Downstream Portion
148 First Flocculator Stage Chemical Injection Port
150 Second Flocculator Stage Chemical Injection Port
152 Third Flocculator Stage Chemical Injection Port
154 First Flocculator Stage Pipe Section
156 Second Flocculator Stage Pipe Section
158 Third Flocculator Stage Pipe Section
160 Aeration Mixing Chamber Pipe Section
162 Aeration Mixing Chamber Inlet
164 Aeration Mixing Chamber Outlet
166a First Effluent Weir First End
166b Second Effluent Weir First End
166c Third Effluent Weir First End
168 Aeration Mixing Chamber Outlet
170a First Effluent Weir Pipe Cross Section
170b Second Effluent Weir Cross Section
170c Third Effluent Weir Cross Section
172a First Effluent Weir Apex
172b Second Effluent Weir Apex
172c Third Effluent Weir Apex
174 Turbine Pump Suction
176 Turbine Pump Discharge
178 Cyclical Drive Mechanism
180 Drive Mechanism First End
182 Drive Mechanism Second End
184 Paddles
186 Paddle Rigid Coupling Flange
188 Paddle Flexible Wiper
190 Sludge Collection Hopper
192 Sludge Pump
194 Sludge Pump Suction
196 Sludge Pump Discharge
198a First Clear Well Riser Top End
198b Second Clear Well Riser Top End
198c Third Clear Well Riser Top End
200a First Clear Well Riser Movable Discharge Member
200b Second Clear Well Riser Movable Discharge Member
200c Third Clear Well Riser Movable Discharge Member
202a First Clear Well Riser Sealing Member
202b Second Clear Well Riser Sealing Member
202c Third Clear Well Riser Sealing Member
204a First Clear Well Riser Locking Member
204b Second Clear Well Riser Locking Member
204c Third Clear Well Riser Locking Member
206a First Effluent Weir Top Portion
206b Second Effluent Weir Top Portion
206c Third Effluent Weir Top Portion
208a First Effluent Weir First Sidewall
208b Second Effluent Weir First Sidewall
208c Third Effluent Weir First Sidewall
210a First Effluent Weir Second Sidewall
210b Second Effluent Weir Second Sidewall
210c Third Effluent Weir Second Sidewall
210a First Effluent Weir First Sidewall Bottom Edge
212b Second Effluent Weir First Sidewall Bottom Edge
212c Third Effluent Weir First Sidewall Bottom Edge
214a First Effluent Weir Second Sidewall Bottom Edge
214b Second Effluent Weir Second Sidewall Bottom Edge
214c Third Effluent Weir Second Sidewall Bottom Edge
216 Separation Tank Bottom Drain

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of view viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

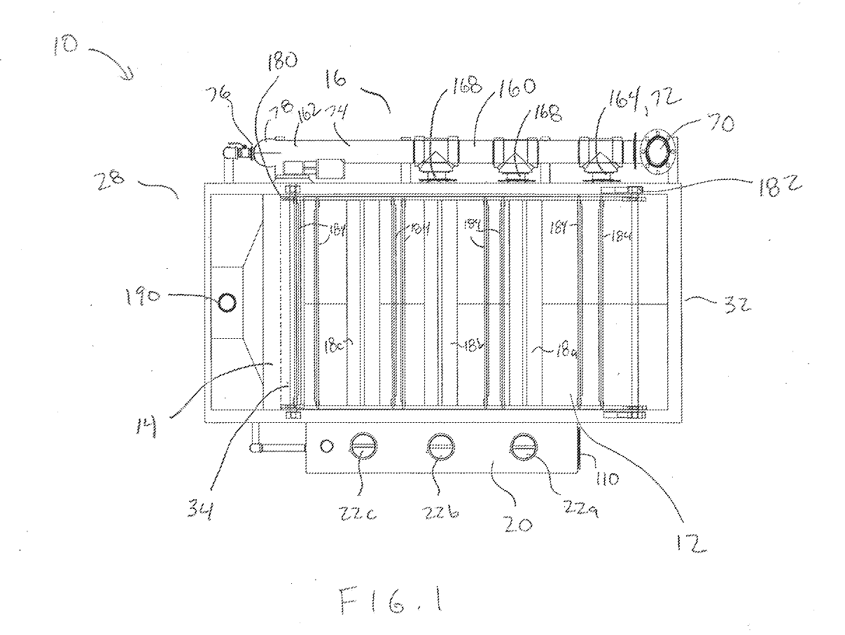

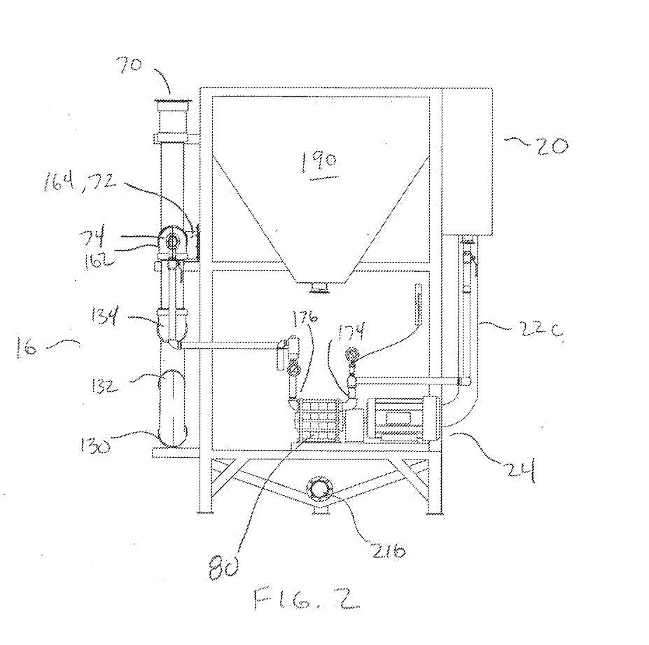

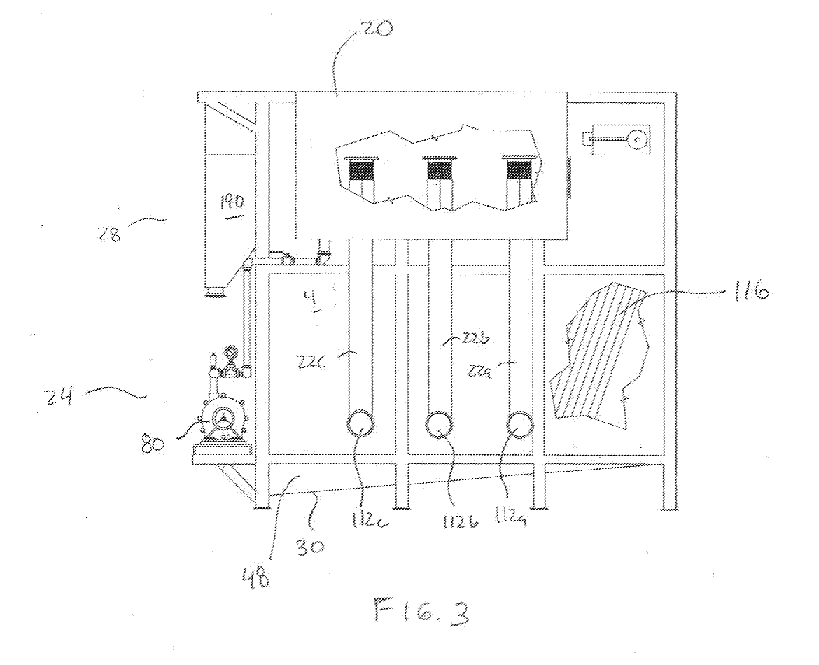

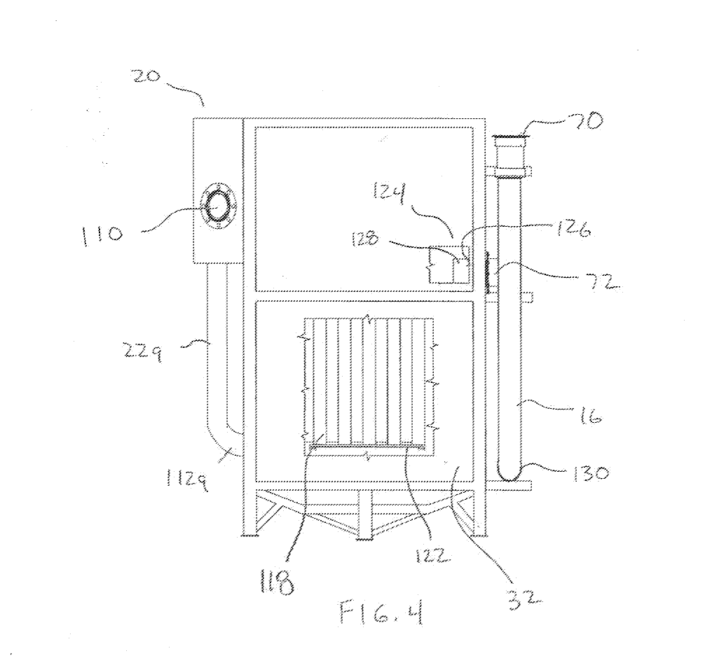

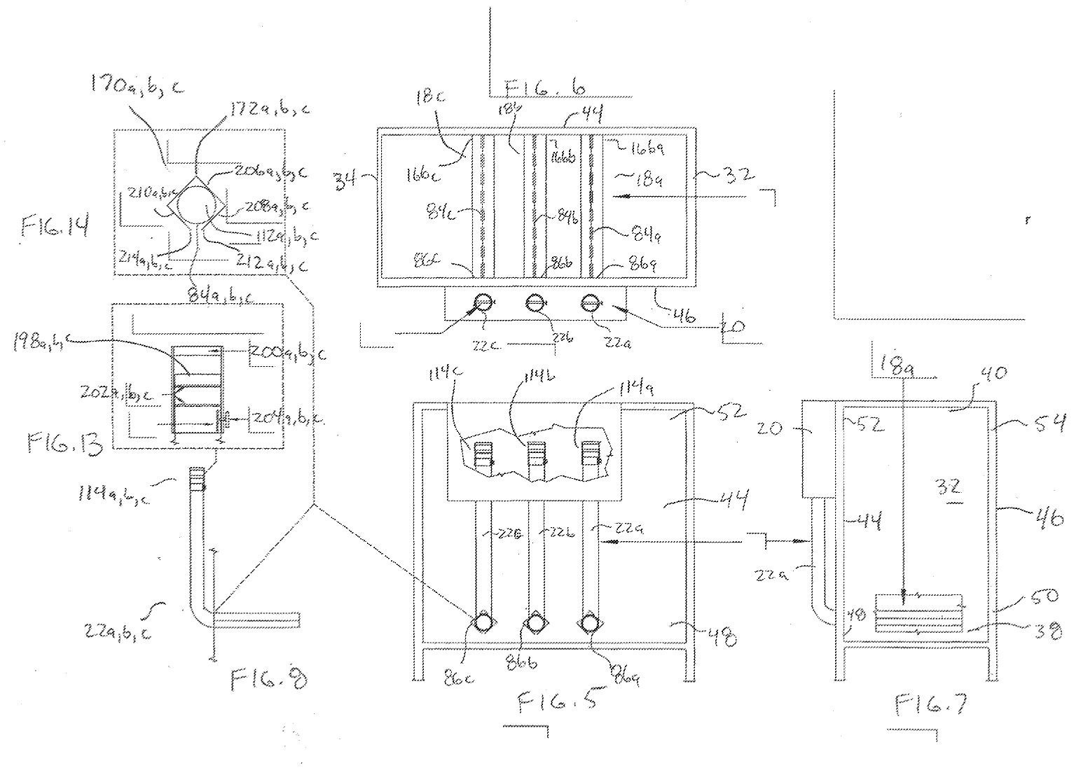

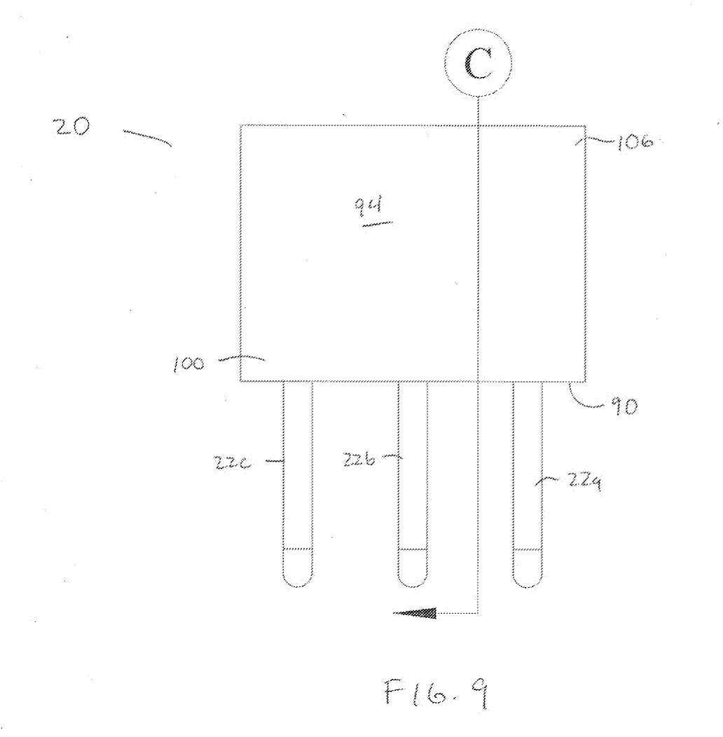

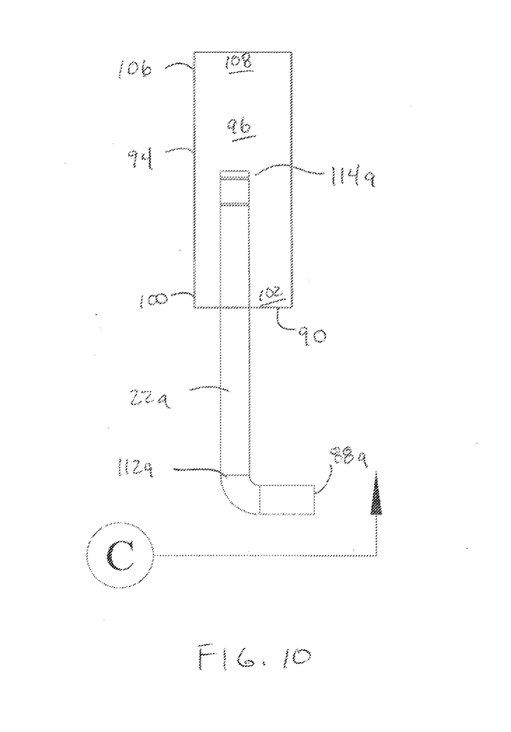

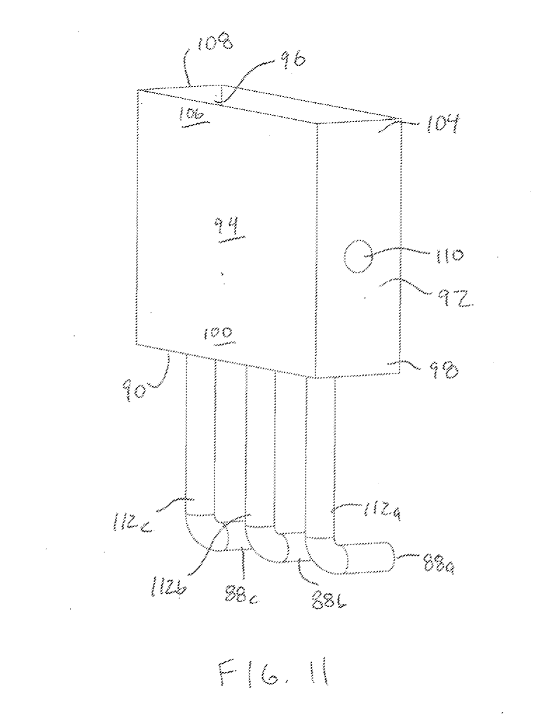

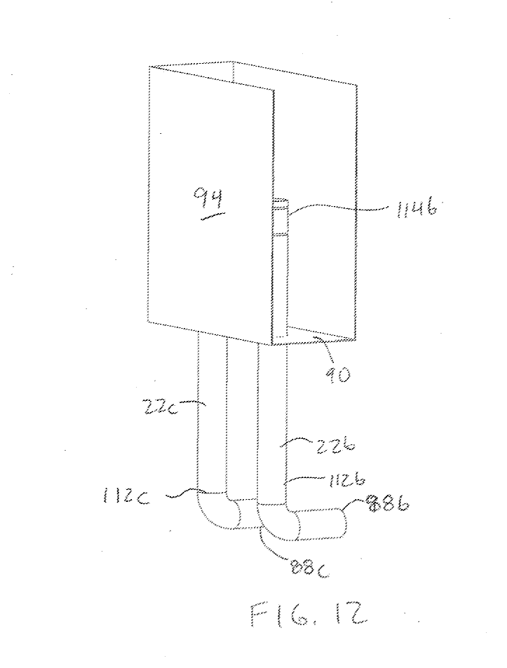

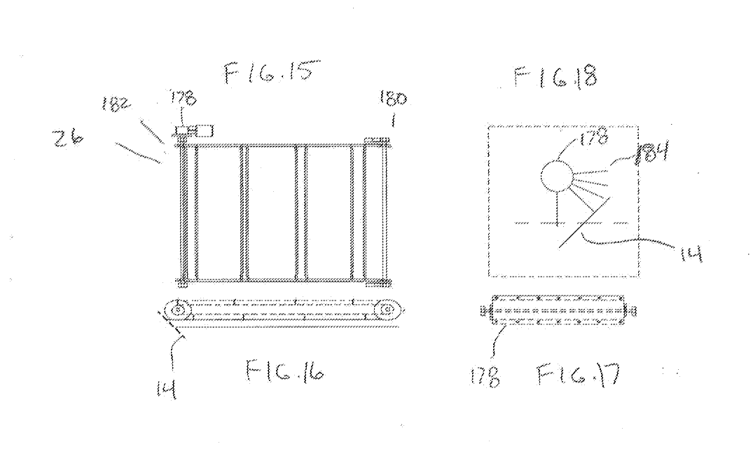

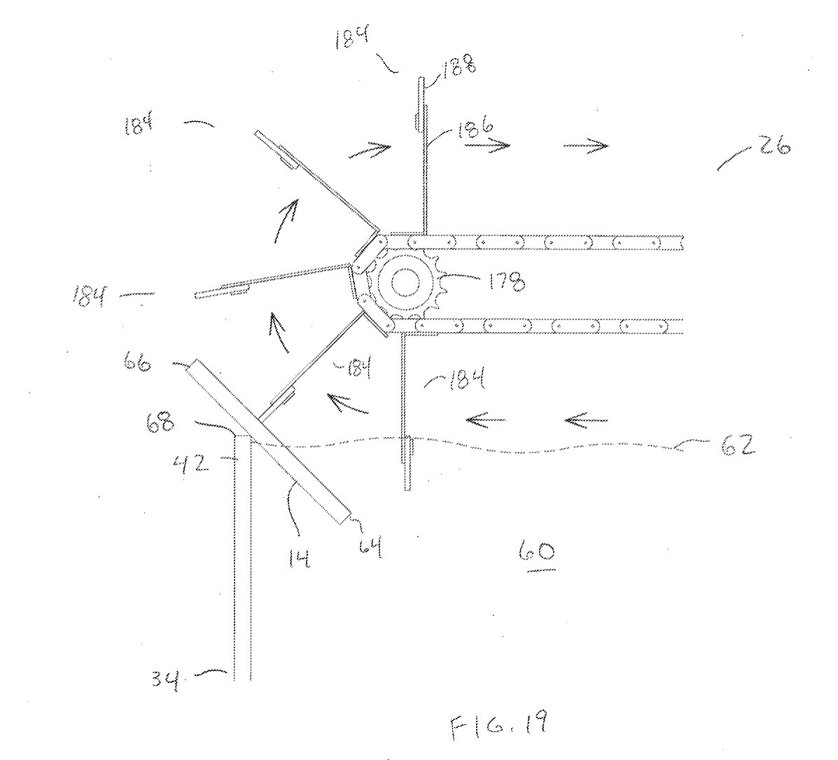

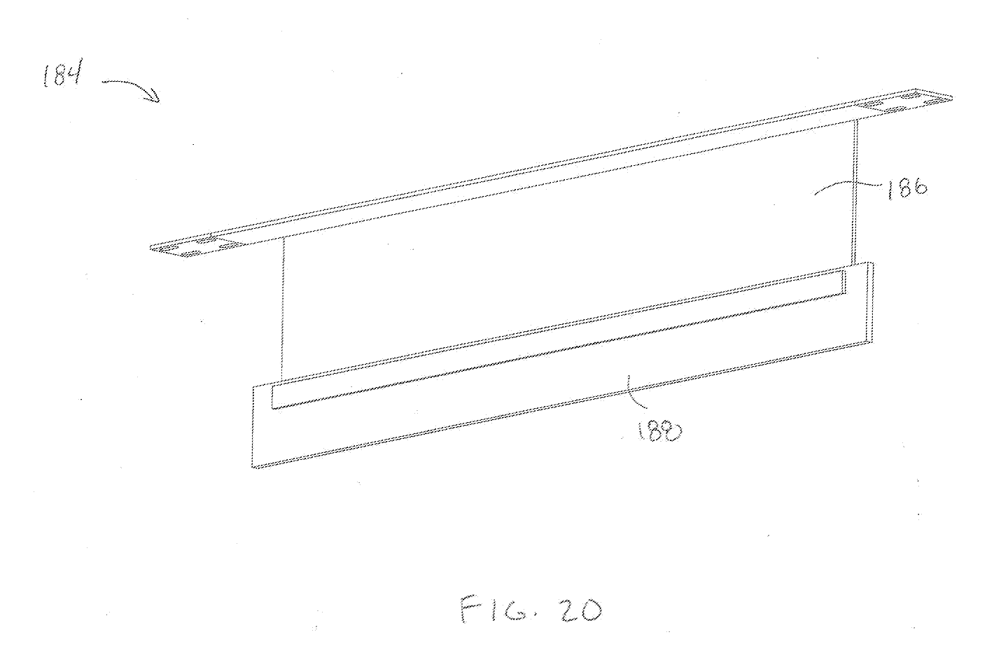

Referring to FIGS. 1-20, a sugar aeration clarifier 10 is shown. The sugar aeration clarifier 10 includes a separation tank 12, a sludge plate 14, a flocculator portion 16, effluent weirs 18a, 18b & 18c, a clear well 20, clear well risers 22a, 22b & 22c, an aeration injector 24, a surface skimmer 26, and a sludge collection portion 28.

Separation tank 12 has a volume defined by a bottom wall 30, opposed first and second end walls 32 and 34, each end wall 32, 34 extending from a bottom portion 36 and 38, respectively, connected to the bottom wall 30 to a top portion 40 and 42, respectively, and opposed parallel first and second side walls 44, 46 each extending from a bottom portion 48 and 50, respectively, connected to the bottom wall 30 to a top portion 52 and 54, respectively.

Sludge plate 14 extends transversely from a first lateral side 56 to a second lateral side 58 proximate the separation tank first and second side walls 44 and 46, respectively. Sludge plate 14 extends longitudinally from a first end 64 positioned in the interior volume 60 of separation tank 12 at a height below the liquid operating level 62 of the apparatus 10, extending to a second end 66 which projects at least to a position proximate the upper edge 68 of the separation tank second end wall 34. In the embodiment, sludge plate second end 66 extends past the upper edge 68 of the separation tank second end wall 34 to allow more drainage of sugar syrup back into separation tank 12 as sludge is pushed into the sludge collection portion 28. Sludge plate 14 is oriented at an inclined angle from horizontal, thereby providing drainage back into separation tank 12, and causing the skimmer paddles to squeeze out additional sugar syrup from the retentate as the retentate is dragged along the surface of sludge plate 14. In the embodiment, the sludge plate 14 angle is within the range 30″ to 50° from horizontal, providing adequate angle for drainage/runoff, but shallow enough of an angle to permit efficient movement of retentate across the plate with flexible paddle materials, as used in the embodiment.

Flocculator portion 16 includes an inlet 70 to receive sugar juice to be clarified, an outlet 72 to discharge into separation tank 12, an aeration mixing chamber 74 disposed between the flocculator inlet 70 and outlet 72, an aeration injection port 76 proximate the upstream end 78 of the aeration mixing chamber 74 and a chemical injection port 152 disposed between the flocculator inlet 70 and the aeration injection port 76.

First effluent weir 18a is mounted within separation tank 12 at a depth proximate the bottom portions of the first and second side walls 48 and 50, respectively, but set off from the bottom wall 30. In the embodiment, second and third effluent weirs 18b & c are similarly mounted in parallel. Each of the effluent weirs 18a, 18b, 18c includes an enclosed top portion 82a, 82b & 82c, respectively, a bottom inlet 84a, 84b & 84c, respectively, and a discharge 86a, 86b & 86c, respectively, in fluid communication with a clear well riser inlet, 88a, 88b & 88c, respectively.

Clear well 20 is mounted adjacent to separation tank 12. In the embodiment, clear well 20 is mounted to separation tank first sidewall 44. Clear well 20 is defined by clear well bottom wall 90 and enclosing clear well first, second and third side walls 92, 94 and 96, each clear well side wall 92, 94, 96 extending from a bottom portion 98, 100, 102, respectively, connected to the clear well bottom wall 90 to a top portion 104, 106, 108, respectively. Clear well 20 includes a clear well discharge 110, which discharges clarified sugar syrup from the apparatus 10 for further processing.

In the embodiment, first, second and third clear well risers 22a, 22b & 22c, respectively, corresponding to first, second and third effluent weirs 18a, 18b & 18c, respectively, are disposed within clear well 20. Each clear well riser 22a, 22b & 22c, extends from a bottom portion 112a, 112b & 112c, respectively, with inlet 88a, 88b, 88c in fluid communication with the corresponding effluent weir discharge 86a, 86b & 86c, respectively, to a riser discharge 114a, 114b & 114c, respectively. The height of the riser discharges 114a, 114b & 114c, is lower than the clear well side wall top portions 104, 106 and 108, and defines the liquid operating level 62 of the apparatus 10.

Aeration injector 24 includes an inlet 174 in fluid communication with the clear well 20 and a discharge 176 in fluid communication with the flocculator aeration injection port 76. In the embodiment, aeration injector 24 comprises an aeration turbine pump 80.

Surface skimmer 26 is mounted atop separation tank 12 and continuously skims the surface of separation tank 12 during operation, to accumulate retentate and push the retentate up and over sludge plate 14 into sludge collection portion 28.

Sludge collection portion 28 is positioned adjacent separation tank second end wall 34 to receive retentate from surface skimmer 26.

In the embodiment, separation tank 12 includes a separator plate pack 116 mounted within the separation tank volume 60. Separator plate pack 116 includes a plurality of spaced apart parallel plates 118, each extending from a top edge 120 to a bottom edge 122, with their top edges 120 below the level of skimmer 26 and oriented at a non-vertical angle. Below the level of skimmer 26 means the top edges 120 are below the level of the part of the skimmer which moves in contact with the liquid in separation tank 12 (in the embodiment, paddles wipers 188) in order to prevent mechanical and flow interference. Each of the effluent weirs 18a-c is mounted below the separator plate pack 116, with the discharge weir top portions 82a, 82b, 82c below level of the bottom edges 122, and at least one of the discharge weirs 18a, 18b, 18c located directly below the plate pack 116. In the embodiment, the angle of the plates 118 of separator plate pack 116 is in the range 55° to 65° from horizontal. In the embodiment, plates 118 are rippled, but may be flat or curved.

In the embodiment separation tank 12 includes an inlet distribution box 124 mounted separation tank 12 proximate the separation tank first side wall 44. Inlet distribution box 124 has an inlet 126 in fluid communication with the flocculator portion outlet 72 and an outlet 128 disposed within the interior volume 60 of separation tank 12 and below the liquid operating level 62, and in fluid communication with the separation tank interior volume 60. Inlet distribution box outlet 128 is below the liquid operating level 62 of the apparatus.

Flocculator portion 16 includes a plurality of flocculator stages 130, 132, 134, respectively, disposed in series. Each flocculator stage 130, 132, 134 extends from an upstream portion 136, 138, 140, respectively, to a downstream portion 142, 144, 146, respectively, with each following stage upstream portion 138, 140 respectively, in fluid communication with the immediately preceding stage downstream portion, 142, 144, respectively. The final flocculator stage 134 is disposed to feed into the aeration mixing chamber 74. Each flocculator stage 130, 132, 134 has a chemical injection port 148, 150, 152, proximate its respective upstream portion 136, 138, 140. In the embodiment, aeration injection port 76 is disposed proximate the upstream end 78 of the aeration mixing chamber 74.

Each flocculator stage 130, 132, 134 includes an elongated section of round pipe 154, 156, 158, respectively, mounted horizontally and oriented in an opposed flow direction from the preceding stage. Aeration mixing chamber 74 also includes an elongated horizontal round pipe section 160 extending from an inlet 162 coupled to the final flocculator stage downstream portion 146 to an outlet 164 feeding directly into the inlet distribution box inlet 126. The mixing chamber pipe section 160 may have a greater cross sectional area than each of the plurality of flocculator stage pipe sections 154, 156, 158, and aeration mixing chamber 74 is oriented in an opposed flow direction from final flocculator stage 134. Aeration mixing chamber 74 may have additional discharges 168 distributed along the length of pipe section 160 feeding into inlet distribution box 124.

In the embodiment, each effluent weir 18a, 18b, 18c consists of an elongated pipe extending from a first end 166a, 166b, 166c, respectively, proximate the separation tank first side wall 44 to its respective effluent weir discharge 86a, 86b, 86c, respectively, proximate the separation tank second side wall 46. Each effluent weir pipe cross section 170a, 170b, 170c, respectively, includes an enclosed top portion 206a, 206b, 206c, respectively, forming a peaked transverse cross-section extending from an apex 172a, 172b, 172c, respectively, downward, and longitudinally opposed first and second sidewalls 208a, 208b, 208c and 210a, 210b, 210c, respectively, extending from the respective top portion 206a, 206b, 206c, to respective first and second sidewall bottom edges 212a, 212b, 212c and 214a, 214b, 214c, respectively. First and second sidewall bottom edges 212a, 212b, 212c and 214a, 214b, 214c are spaced apart from each other to define a longitudinally-oriented open bottom inlet channel 84a, 84b, 84c, respectively, providing fluid communication between the pipe interior and the separation tank 12 interior volume 60. Effluent weir portion discharges 86a, 86b, 86c, respectively, are adapted to couple to first sidewall 44 of separation tank 12. In the embodiment, each effluent weir pipe cross section 170a, 170b, 170c defines a diamond shape oriented with closed apex 172a, 172b, 172c, respectively, on top. Cross sections 170a, 170b, 170c are square diamonds (except that the bottom inlets 84a, 84b, 84c render the cross sections not complete squares, thereby rendering them “substantially square”). Effluent weir cross sections 170a, 170b, 170c of each of the respective effluent weirs 18a, 18b, 18c extends radially beyond the interior cross section of the corresponding clear well riser bottom portion 112a, 112b, 112c, respectively.

The height of each of the clear well riser discharges 114a, 114b, 114c, respectively, is adjustable. Each clear well riser 22a, 22b, 22c includes an open top end 198a, 198b, 198c, respectively, with a movable riser discharge member 200a, 200b, 200c slidingly engageable over the respective clear well riser top end 198a, 198b, 198c. Sealing members 202a, 202b, 202c are disposed between the clear well riser top ends 198a, 198b, 198c and the movable riser discharge members 200a, 200b, 200c, respectively, to seal there between. In the embodiment, movable riser discharge members 200a, 200b, 200c are sleeves with sealing members 202a, 202b, 202c, being sets of O-rings disposed between the sleeve interiors and the open top ends 198a, 198b, 198c, respectively. Each also includes a locking member 204a, 204b, 204c selectively engageable against its respective movable riser discharge member 200a, 200b, 200c and its respective clear well riser top end 198a, 198b, 198c at user-selectable heights. In the embodiment, locking members 204a, 204b, 204c are set screws which can selectively engage a series of dimples disposed vertically along riser top ends 198a, 198b, 198c, respectively.

In the embodiment, aeration injector 24 includes a turbine pump 80 having a suction 174 in fluid communication with the clear well 20, such that turbine pump 80 recycles sugar syrup from clear well 20 during normal operation. Turbine pump discharge 176 is in fluid communication with aeration injection port 76. The regenerative turbine pump preferably operates at discharge pressure of 20-100 psig, fed with sugar syrup from the clear well and mixed with either ambient air or compressed air, according to operator preference. The aeration-recirculation portion generates 20-30 micron bubbles at a gas saturation rate 6-10% by volume of re-circulated sugar syrup. The sugar syrup is re-circulated at a rate of 10-50% of the sugar aeration clarifier influent feed rate, depending on the purity of the incoming raw sugar juice and the desired purity of the discharge.

Surface skimmer 26 includes a cyclical drive mechanism 178 mounted above separation tank 12 and extending from a first end 180 proximate the separation tank second end wall 34 to a second end 182 proximate the separation tank first end wall 32. A plurality of paddles 184 are coupled to drive mechanism 178 each of the plurality of paddles 184 extending transversely across separation tank 12.

Cyclical drive mechanism 178 cyclically moves each paddle 184 of the plurality of paddles 184 from approximately the separation tank first end wall 32 to approximately the separation tank second end wall 34 into contact with and over sludge plate 14 thereby skimming retentate from the surface (i.e. the liquid operating level 62) of the sugar syrup in separation tank 12 and moving the retentate across sludge plate 14 surface into the sludge collection portion 28.

Each paddle 184 includes a rigid coupling flange 186 adapted to couple to the cyclical drive mechanism 178 and a flexible wiper 188 coupled to and extending beyond rigid coupling flange 186. Each flexible wiper 188 extends far enough to penetrate surface of the syrup (i.e. lower than the liquid operating level 62 during normal operation) and engage along the surface of sludge plate 14 to push retentate off sludge plate 14 into sludge collection portion 28, in the embodiment, the liquid operating level 62 is adjustable within a range by adjusting the clear well riser discharge 114a, 114b, 114c heights, so preferably the flexible wipers 188 extend far enough to account for this variation.

In the embodiment, sludge collection portion 28 includes sludge collection hopper 190 abutting separation tank second end wall 34 and sludge pump 192 having a suction 194 in fluid communication with the sludge collection hopper 190 and a discharge 196 connectable to a sludge disposal system or further processing equipment.

In operation of the described embodiment 10, sugar syrup to be clarified is received into the system at the system inlet, which in the embodiment is the flocculator portion inlet 70. The sugar syrup passes through the first, second and third flocculator stages 130, 132, 134, respectively, with the flow direction reversed approximately 180 degrees with each successive stage. Chemical dosing may be added through any, all or none of first, second and third flocculator stage chemical injection ports 148, 150, 152, respectively, as determined by the operator. Chemical injection ports 148, 150, 152 are disposed at the upstream portions 136, 138, 140 of the flocculator stages to enhance mixing, and provide maximum dwell time with the chemicals in the flocculator stream to allow time for agglomeration to occur. Proof testing has determined that a flocculator dwell time in the range 5 seconds to 120 seconds is preferred for most processing applications. Aerated sugar juice from the aeration injector 24 is injected into the stream through aeration injection port 76, downstream of the flocculator stages 130, 132, 134 and at the upstream end 78 of aeration mixing chamber 74. Aeration mixing chamber 74 has a higher cross-sectional area than the flocculator stages, which accounts for the additional mass flow from aeration injector 24 as well as slowing down and partially depressurizing the aerated syrup from aeration injector 24, thereby initiating gas bubble-particle adhesion and thorough fluid mixing, as well as gas bubble adherence to agglomerated flocculent particles.

The mixed, aerated syrup then passes into separation tank 12 via inlet distribution box 124, which evenly distributes flow across separation tank 12 and further slows the fluid velocity, ensuring the entire fluid mass flows evenly across separator plate pack 116 and achieves fairly uniform dwell time. Aerated sugar syrup flows across parallel separator plates 118 in plate pack 116 and down toward effluent weirs 18a, 18b, 18c. Separator plates 118 serve to change flow direction, ensure laminar flow, and provide a large effective surface area, enhancing separation of agglomerated particles in the fluid mass, causing lighter particles adhered to gas bubbles to rise to the surface for skimming and heavier particles to sink to the tank bottom for removal through the drain system.

Surface skimmer 26 cyclically moves paddles 184 along the fluid surface, moving floating agglomerated particles to sludge plate 14, then dragging this collected retentate mud up the inclined sludge plate 14. This process of pushing the mud up sludge plate 14 compresses the mud and acts to squeeze out additional filtrate, which drains down sludge plate 14 back into separation tank 12, improving overall yield and efficiency. Surface skimmer 26 continues on to push the mud over the sludge plate edge 66 into collection hopper 190 for disposal or further processing. Sludge pump 192 could be aligned to discharge to a waste stream or to feed mud to a follow-on process. Sludge collection portion 28 could alternatively be the inlet stage of a follow-on process to allow continuous processing of the mud.

Sugar syrup flows downward along, between and around separator plates 118, then flows up into the bottom inlets 84a, 84b, 84c, of effluent weirs 18a, 18b and 18c, respectively. The effluent weir bottom inlets 84a, 84b, 84c, separate heavy/sinking particulates from the clarified effluent syrup stream. The effluent weir peaked top portions 82a, 82b, 82c, reduce accumulation of particulate matter to provide greater recovery of heavier “mud” through the separation tank bottom drain 216, and to provide easier system cleaning.

Clarified effluent sugar syrup, which is now substantially free of particulate contaminants, flows through effluent weirs 18a, 18b, 18c, and into corresponding clear well risers 22a, 22b, 22c, to overflow into clear well 20, where the fluid is either discharged through clear well discharge 110 for further processing steps, or recycled into the system through aeration injector 24. Aeration injector 24 is a turbine pump 80 which preferably can operate at adjustable flow rates in order to vary the ratio of recycled to discharged clarified effluent. The overflow through clear well risers 22a, 22b, 22c, allows the designer to set the liquid operating level 62 of the system by selecting the riser height, and through the overflow process provides additional removal of any remaining gas bubbles in the clarified syrup. In the embodiment, adjustable height clear well risers 22a, 22b, 22c allow the apparatus operator to set the liquid operating level, by disengaging locking members 204a, 204b, 204c, sliding movable discharge members 200a, 200b, 200c to the desired height, and reengaging the locking members. Proof testing has determined that an overall system dwell time—i.e. the time from sugar syrup entering the flocculator portion inlet to passing through clear well discharge—in the range of 10 minutes to 30 minutes is preferred for most processes. Effective system dwell time may be increased by increasing the proportion of effluent recycled through aeration injector 24.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

I claim:

1. An apparatus for clarifying sugar syrup, comprising:
a separation tank having a volume defined by a bottom wall, opposed first and second end walls each extending from a bottom portion connected to the bottom wall to a top portion, and opposed parallel first and second side walls each extending from a bottom portion connected to the bottom wall to a top portion;
a sludge plate extending transversely from the first to the second side walls and extending longitudinally from an interior region of the separation tank at a height below the liquid operating level of the apparatus to at least the upper edge of the separation tank second end wall, the sludge plate oriented at an inclined angle from horizontal;
a flocculator portion having an inlet, an outlet in fluid communication with the separation tank, an aeration mixing chamber disposed between the flocculator inlet and outlet, an aeration injection port proximate an upstream end of the aeration mixing chamber, and a chemical injection port disposed between the flocculator inlet and the aeration injection port;
one or more effluent weirs mounted within the separation tank at a depth proximate the bottom portions of the first and second side walls but set off from the bottom wall, each of the one or more effluent weirs having an enclosed top portion, a bottom inlet, and a discharge in fluid communication with a clear well riser;
a clear well adjacent to the separation tank, the clear well defined by a clear well bottom wall and enclosing clear well side walls extending to a respective clear well side wall top portion, the clear well further including a clear well discharge;
one or more clear well risers corresponding to the one or more effluent weirs disposed within the clear well, each of the one or more clear well risers extending from a bottom portion in fluid communication with the corresponding effluent weir discharge to a riser discharge, wherein the height of the riser discharge is lower than the clear well side wall top portions and defines the liquid operating level of the apparatus;
an aeration injector having an inlet in fluid communication with the clear well and a discharge in fluid communication with the flocculator aeration injection port;
a surface skimmer; and,
a sludge collection portion adjacent the separation tank second end wall to receive retentate from the surface skimmer.

2. The apparatus of claim 1, further comprising:
wherein the sludge plate angle is within the range 30° to 50° from horizontal.

3. The apparatus of claim 1 wherein the separation tank further comprises a separator plate pack mounted within the separation tank, the separator plate pack including a plurality of spaced apart parallel plates having their top edges below the level of the skimmer and oriented at a non-vertical angle, wherein each of the one or more effluent weirs is mounted below the separator plate pack.

4. The apparatus of claim 3 wherein the separator plate pack angle is in the range 55° to 65° from horizontal.

5. The apparatus of claim 1, wherein the separation tank further comprises a inlet distribution box mounted within the separation tank proximate the separation tank first side wall below the liquid operating level, the inlet distribution box having an inlet in fluid communication with the flocculator portion discharge and an outlet in fluid communication with the separation tank interior volume.

6. The apparatus of claim 1, the flocculator portion further comprising:
a plurality of flocculator stages disposed in series, each flocculator stage extending from an upstream portion to a downstream portion with each following stage upstream portion in fluid communication with the immediately preceding stage downstream portion, the final flocculator stage disposed to feed into the aeration mixing chamber, each flocculator stage having a chemical injection port proximate its respective upstream portion;
wherein the aeration injection port is disposed proximate the upstream end of the aeration mixing chamber.

7. The apparatus of claim 6, further comprising:
each flocculator stage further comprising an elongated section of pipe mounted horizontally and oriented in an opposed flow direction from the preceding stage; and,
the aeration mixing chamber further comprising an elongated horizontal pipe extending from an inlet coupled to the final flocculator stage downstream portion to one or more aeration chamber outlets in fluid communication with the inlet distribution box, the aeration mixing chamber oriented in an opposed flow direction from the final flocculator stage.

8. The apparatus of claim 1, each effluent weir further comprising:
an elongated pipe extending from a first end proximate the separation tank first side wall to the effluent weir discharge proximate the separation tank second side wall, the pipe cross section comprising a diamond shape oriented with a closed apex on top.

9. The apparatus of claim 8, further comprising:
wherein the effluent weir pipe cross section is substantially square.

10. The apparatus of claim 8, further comprising:
wherein the interior cross section of each of the one or more effluent weirs extends radially beyond the interior cross section of the corresponding clear well riser lower portion.

11. The apparatus of claim 1, further comprising:
wherein the height of each of the one or more clear well riser discharges is adjustable.

12. The apparatus of claim 1, wherein the aeration injector comprises a turbine pump including a suction in fluid communication with the clear well, such that the turbine pump recycles sugar syrup from the clear well during normal operation.

13. The apparatus of claim 1, the surface skimmer further comprising:
a cyclical drive mechanism mounted above the separation tank and extending from a first end proximate the separation tank second end wall to a second end proximate the separation tank first end wall;
a plurality of paddles coupled to the drive mechanism, each of the plurality of paddles extending transversely across the separation tank;
each of the plurality of paddles movable from approximately the first end wall approximately the second end wall and into contact with and over the sludge plate.

14. The apparatus of claim 13, each paddle comprising:
a rigid coupling flange adapted to couple to the cyclical drive mechanism; and,
a flexible wiper coupled to and extending beyond the rigid coupling flange, the extended portion of the flexible wiper sufficient to contact the liquid operating level and the sludge plate during normal operation.

15. The apparatus of claim 1, the sludge collection portion further comprising:
a sludge collection hopper abutting the separation tank second end wall, the hopper connectable to a sludge pump.

16. The apparatus of claim 11, further comprising:
each clear well riser further including an open top end;
a moveable weir discharge member slidingly engageable over the clear well riser top end;
a sealing member disposed between the clear well riser top end and the movable weir discharge member; and,
a locking member selectively engageable against the movable weir discharge member and the clear well riser top end at user-selectable heights.

17. An apparatus for clarifying sugar syrup, comprising:
a liquid tank having sidewalls and a bottom wall,
a collector, the collector including an effluent weir portion adapted to mount below the normal operating liquid level of the tank and a discharge portion in fluid communication with the effluent weir portion,
the effluent weir portion further comprising:
an elongated pipe extending longitudinally from a first end to a second end, the pipe including an enclosed top portion forming a peaked transverse cross-section extending from an apex downward, and longitudinally opposed first and second sidewalls extending from the respective top portion to respective first and second sidewall bottom edges, the first and second sidewall bottom edges spaced apart from each other to define a longitudinally-oriented open bottom channel providing fluid communication between the pipe interior and the tank interior volume, and further wherein the effluent weir portion second end is adapted to couple to a sidewall of the liquid tank; and,
the discharge portion comprising a riser extending from an inlet couplable to the tank sidewall exterior in fluid communication with the effluent weir portion second end, and an outlet disposed higher than the inlet.

18. The apparatus of claim 17, the discharge portion further comprising:
a height-adjustable discharge portion outlet.

19. The apparatus of claim 18, the discharge portion further comprising:
a movable sleeve member slidingly engageable over the riser outlet;
a sealing member disposed between the outlet and the movable sleeve member; and,
a locking member selectively engageable against the movable weir discharge member and the riser outlet at user-selectable heights.

20. The apparatus of claim 17, further comprising:
wherein the transverse cross section of the collection portion pipe second end extends beyond the cross-section of the discharge portion inlet.
